(19) United States
(12) Patent Application Publication
(10) Pub. No.: US 2014/0136321 A1
(43) Pub. Date: May 15, 2014

(54) SYSTEM FOR PUBLISHING CONTENT IN MARKETING COMMUNICATIONS ACROSS DIGITAL MEDIA IN ONLINE ADVERTISING

(71) Applicants: Robert O. Bolan, Hunts Point, WA (US); William Nicholas Weir, Phoenixville, PA (US)

(72) Inventors: Robert O. Bolan, Hunts Point, WA (US); William Nicholas Weir, Phoenixville, PA (US)

(73) Assignee: ChoozOn Corporation, King of Prussia, PA (US)

(21) Appl. No.: 13/673,952

(22) Filed: Nov. 9, 2012

(51) Int. Cl. G06Q 30/02

(52) U.S. Cl. 705/14.53; 705/14.73; 705/14.71

(57) ABSTRACT

An improved system and method for publishing content in marketing communications across digital media is provided. Marketing communications, including marketing emails, may include information about offers and advertising information for using the offers in online advertising such as advertising channel information, monetization information, and social sharing information. Upon receiving the marketing communications, offer information and advertising information may be extracted from the marketing communications. Offers may be generated from the offer information extracted from the marketing communications, and the offers and advertising information may be stored in persistent storage. A request may be received, for instance from an advertisement server or advertisement exchange network, to serve an advertisement for an advertising channel to the user. And an offer extracted from the marketing communications sent to the user may be served as an advertisement to a device operated by the user for display.

### CROSS-REFERENCE TO RELATED APPLICATIONS

The present invention is related to the following United States patent application, filed concurrently herewith and incorporated herein in its entirety:

“Method for Publishing Content in Marketing Communications across Digital Media in Online Advertising,” Attorney Docket No. 0050.

### FIELD OF THE INVENTION

The invention relates generally to computer systems and more particularly to an improved system and method for publishing content in marketing communications across digital media in online advertising.

### BACKGROUND OF THE INVENTION

Email marketing, or sending marketing messages through email, is one of the most widely used direct-marketing methods. One reason for email marketing's popularity is that it is relatively inexpensive to design, test, and send an email message. Email marketing also allows marketers to deliver messages anytime and to accurately measure responses. Unlike some other forms of mass media, email marketing enables “mass customization” of messages on an individual or trait-segmented basis, because the email address can be associated uniquely with an individual consumer and the consumer's behavioral profile. It has been estimated that almost half of American internet users check or send email daily. In fact, many consumers prefer to receive permissioned-based promotions via email and prefer email as a channel for brand communications. It is no wonder that email marketing is a multi-billion dollar business and accounts for billions in sales.

State-of-the-art email marketing services and solutions support database integration, segmentation and various other technologies and techniques for improving the targeting of outgoing messages. Advanced methods enable dynamically generated emails customized to an individual recipient based on trigger events in real time. While many marketers recognize the financial benefits of increasing targeted awareness, some direct marketing efforts using particular media have been criticized for generating poor quality leads, either due to poor message or delivery strategy or because of poorly compiled demographic databases. Worse yet, some marketing communications sent by email represent unsolicited bulk email messages, also known as “spam,” sent indiscriminately to a large number of consumers. In either case, this poses a problem for marketers and consumers alike, as advertisers do not wish to waste money on communicating with consumers not interested in their products, and don't want their relevantly-targeted messages overlooked or discounted amidst a flood of spam mass-mailings. And consumers generally dislike receiving marginally relevant, unsolicited mass emails that require time to manage in their personal email inbox.

Consumers have further expressed concerns about the privacy implications of email marketing. Email promotions and offers generate immediate action online and offline: sales, downloads, inquiries, registrations, social sharing, and so forth. How this information is collected by marketers, what online activities are tracked by marketers, and how this information is shared by marketers is of concern to consumers. Consumers are demanding more control of the personal information collected about them, including the right to approve or disapprove of user-data collection and tracking in advance, as well as the ability to add, delete or modify their personal information stored in marketers' databases. Nonetheless, some marketers retain the right to sell personal information to outside parties unless consumers specifically opt-out. Fortunately, consumers are more willing to provide information voluntarily if online companies can provide sufficient value in exchange for that information, can engender a sense of trust, can provide consumers with control of their personal information and can alleviate online privacy concerns.

What is needed is a system and method that gives consumers more control over the marketing communications they receive in their email and marketers the ability to perform effective direct marketing using email marketing to support sales through other advertising channels. Such a system and method should strengthen relationships, encourage trust and cement loyalty between consumers and brands, in addition to enhancing the return on investment by marketers.

### SUMMARY OF THE INVENTION

Briefly, the present invention may provide a system and method for publishing content in marketing communications across digital media. In various embodiments, a user client may be operably connected to a marketing client, an offer server, an ad server, and either a search server, a publisher server, or both. The marketing client may include functionality for receiving a request to generate a marketing communication, functionality for tagging the marketing communication, and functionality for sending the marketing communication to the user client or to a user's marketing communication inbox. Marketing messages delivered to a user's marketing communication inbox may be stored for email accounts in a messaging database and may be periodically processed to extract offers from the marketing communications received in an embodiment. These marketing messages may be tagged to identify and delineate information about an offer, and these marketing messages may also be tagged to include and delineate information for use in publishing an offer as an advertisement across digital media.

In general, the offer server may include functionality in various embodiments for providing promotional offers and offer lists, for generating offers from marketing communications, and for responding to requests to serve an advertisement or to bid on a request to serve an advertisement. For instance, the offer server may include a message processor which may be operably coupled with a database engine and an offer generating engine. The message processor may include functionality to process marketing messages and may periodically receive marketing messages from marketing communications inboxes for user email accounts in various embodiments. And the offer generating engine may include functionality to extract offer information from marketing messages, generate offers and load the offers into the offer server storage. The offer generating engine may also include functionality to extract advertising information for publishing content in marketing communications across digital media in online advertising and to load advertising information into the offer server storage. The offer server may also include an advertising engine which may be operably coupled with a database engine and which may generally support services for receiving a request to serve an advertisement or to bid on a request to serve an advertisement and for responding to the request to serve an advertisement or to bid on a request to serve an advertisement. In various embodiments, the advertising engine may provide functionality to support third-party ad serving including functionality to respond to a request from an advertisement exchange server to bid on serving an advertisement.

An ad server may communicate with the user client, the search server, and the publisher server in an embodiment. The ad server may include functionality of an advertisement exchange server for third-party ad serving in various embodiments and may provide services for publisher servers to add executable instructions to display online advertisements on a client device within allocated space of a web page of content published by the publisher servers. The ad server may also include functionality in various embodiments of an advertisement exchange server for third-party ad serving in sponsored search advertising applications and provide services for search servers to add executable instructions to display online advertisements on a client device within allocated space of a web page of search results returned by the search servers. The ad server may further include functionality for conducting a real-time auction online by requesting real-time bids for third-party ad serving.

To publish contents of marketing communications across digital media in online advertising in an embodiment, a tagged marketing message with information about one or more offers and information for using the one or more offers in online advertising may be sent, for instance, by a brand or marketer. The tagged marketing message may be received by a message processing facility such as the message processor, and information about one or more offers and information for using the one or more offers in online advertising may be extracted from the tagged marketing message. In various embodiments, advertising channel information, monetization information, and social sharing information may be extracted from the tagged marketing message as part of the advertising information for using the one or more offers in online advertising. Advertising channels may be configured for serving the one or more offers that may be extracted from the tagged marketing message. Examples of advertising channels may be search advertising including sponsored search advertising, display advertising including targeted display advertising and direct marketing display advertising, email advertising, instant messaging advertising, location-based mobile advertising, general third-party advertisement serving, and other advertising channels for publishing content in marketing communications across digital media in online advertising. A request may be received, for instance from an advertisement server or advertisement exchange network, to serve an advertisement for an advertising channel to a user. And an advertisement may be served to a device operated by the user for display on the device.

Advantageously, the present invention may receive marketing communications, including marketing emails, generate offers from marketing communications, and publish the offers as advertisements across digital media. Conveniently, the present invention may provide marketers the ability to perform effective direct marketing using email marketing to support sales through other advertising channels. Those skilled in the art will appreciate that any number of advertising channels may be supported by the present invention and any number of configurations of advertisement servers may be employed such as an advertisement server, an advertisement exchange network, functionality in various embodiments for third-party ad serving in sponsored search advertising applications, functionality for conducting a real-time auction online by requesting real-time bids for third-party ad serving, and so forth.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for publishing content in marketing communications across digital media, in accordance with an aspect of the present invention;

FIG. 3 is a block diagram generally representing an exemplary architecture of system components of the offer server, in accordance with an aspect of the present invention;

FIG. 4 is a flowchart generally representing the steps undertaken in an embodiment for publishing content in marketing communications across digital media, in accordance with an aspect of the present invention;

FIG. 5 is a flowchart generally representing the steps undertaken in an embodiment for sending a marketing message to a marketing communication inbox, in accordance with an aspect of the present invention;

FIG. 6 is a flowchart generally representing the steps undertaken in an embodiment for tagging a marketing message, in accordance with an aspect of the present invention;

FIG. 7 is a flowchart generally representing the steps undertaken in an embodiment for processing a marketing message to generate an offer, in accordance with an aspect of the present invention;

FIG. 8 is a flowchart generally representing the steps undertaken in an embodiment for extracting advertising information from a marketing communication that may be applied in publishing one or more offers as an advertisement across digital media in online advertising, in accordance with an aspect of the present invention;

FIG. 9 is a flowchart generally representing the steps undertaken in an embodiment for processing social sharing information to publish marketing communications across digital media in online advertising, in accordance with an aspect of the present invention;

FIG. 10 is a flowchart generally representing the steps undertaken in one embodiment for serving offers extracted from marketing communications as advertisements to a user, in accordance with an aspect of the present invention; and

FIG. 11 is a flowchart generally representing the steps undertaken in one embodiment for responding to a request for a bid from an advertising channel to serve an advertisement to a user, in accordance with an aspect of the present invention.

### DETAILED DESCRIPTION

### Exemplary Operating Environment

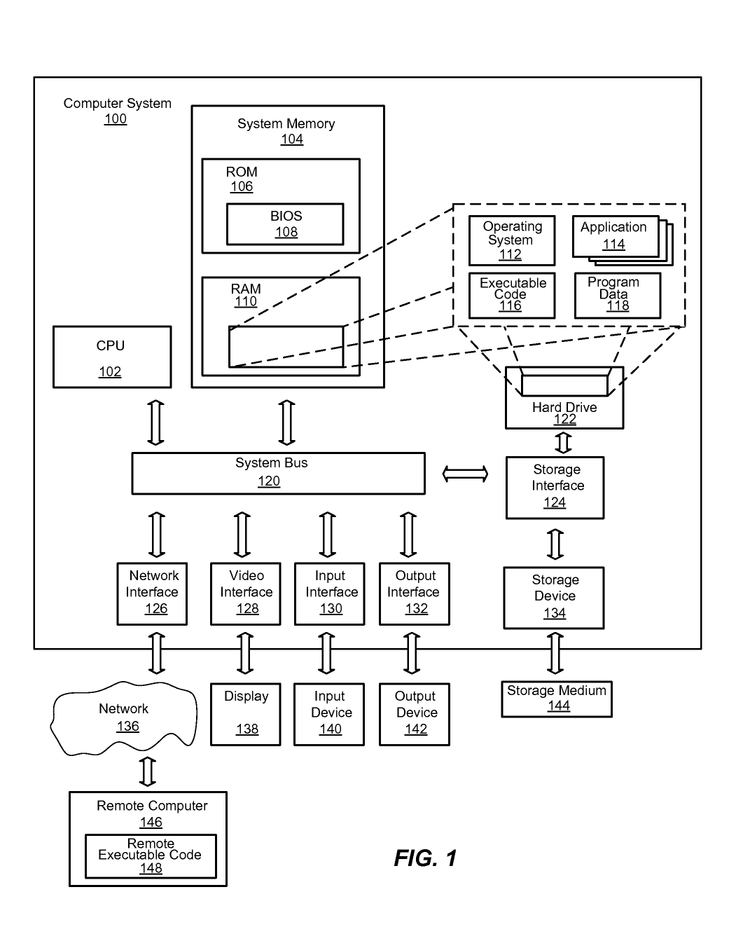

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, flash drives, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

### Publishing Content in Marketing Communications Across Digital Media in Online Advertising

The present invention is generally directed towards a system and method for publishing content in marketing communications across digital media in online advertising. More particularly, the present invention provides the facility to tag content in a marketing communication, such as one or more offers, for use in advertising, to extract and store the tagged content for use in advertising, and to serve the content to a user in response to a request to serve an advertisement in online advertising. As used herein, a marketing communication may mean a variety of content for marketing goods or services including text, voice, images, music, video, audio, other multimedia content and so forth, and such marketing communications may be sent in various embodiments by messaging applications like email applications, instant messaging applications, and other messaging applications. A marketing message as used herein may mean a marketing communication.

As will be seen, promotional offers may be generated from content extracted from marketing communications and stored for serving to users of an online offer service. As used herein, an offer or promotional offer means any online promotion for goods or services, including without limitation coupons, vouchers, advertisements, and so forth. The marketing communications may also be tagged to include and delineate information for use in publishing an offer as an advertisement across digital media in online advertising. Such information may include ad channel information, monetization information, social sharing information, and so forth. Moreover, as will be understood, the various block diagrams, flow charts, and illustrations described herein are only examples, and there are many other scenarios to which the present invention will apply.

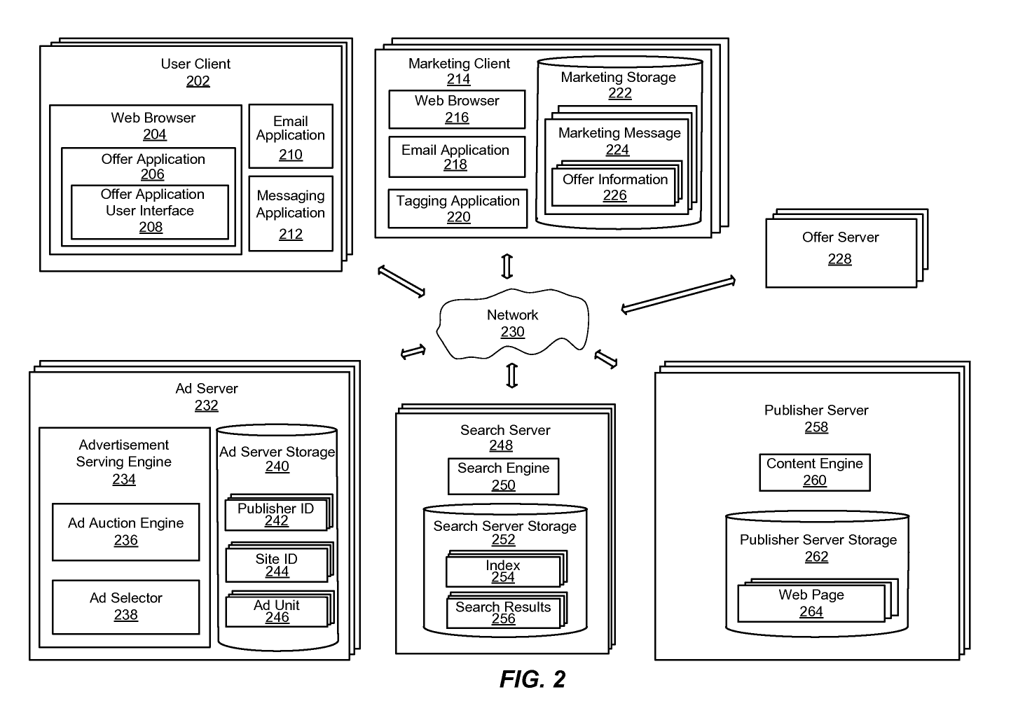

Turning to FIG. 2 of the drawings, there is shown a block diagram generally representing an exemplary architecture of system components for publishing content in marketing communications across digital media in online advertising. Those skilled in the art will appreciate that the functionality implemented within the blocks illustrated in the diagram may be implemented as separate components or the functionality of several or all of the blocks may be implemented within a single component. For example, the functionality for the offer application 206 on the client 202 may be implemented as a separate component from the web browser 204, which may be the case for a mobile device such as a smartphone. Note that in an embodiment on a mobile device, the functionality of the offer application 206 may be implemented both within the web browser 204 as shown and as a separate component so that a mobile device user may use either the web browser 204 with the functionality of the offer application 206 included or the offer application 206 as a separate application component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality of the present invention may also be implemented using a thin client whereby the functionality of the web browser 204, the offer application 206, the email application 210, and the messaging application 212 may be implemented on the offer server 228. In such an embodiment, the client 202 merely acts as an interface for a user to interact with the offer server 228.

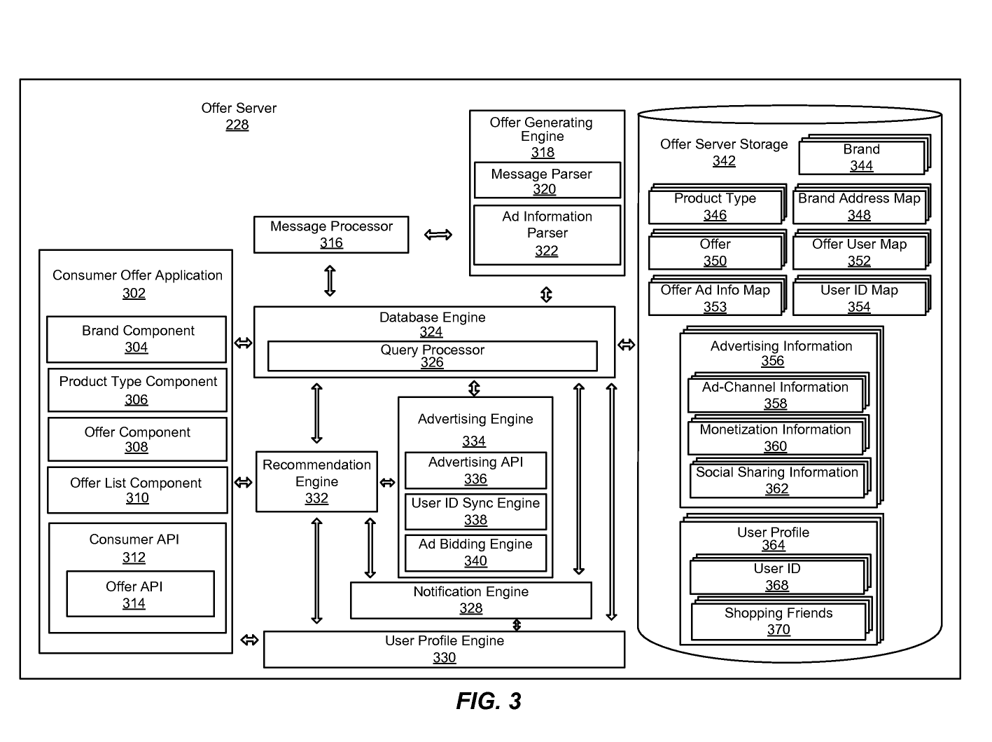

In various embodiments, a user client 202 may communicate through a network 230 with one or more offer servers 228, which are described in further detail in conjunction with FIG. 3 below. The user client 202 may be a computer such as computer system 100 of FIG. 1 or another computing device including a mobile device such as a mobile phone. The network 230 may be any type of network such as a local area network (LAN), a wide area network (WAN), or other type of network, including a mobile network. A web browser 204 may execute on the user client 202 and may include functionality for receiving a request to perform an operation which may be input by a user and functionality for sending the request to a server to perform the operation. The web browser 204 may be operably coupled to an offer application 206 having functionality for receiving requests to perform an operation for the offer application 206 and functionality for sending the requests to the offer server 228 to perform the requested operation for the offer application. The offer application 206 may be operably coupled to an offer application user interface 208 having functionality for visualization and navigation of a graphical user interface for requesting and displaying information about offers available from multiple offer sources, such as brands, product types, offer lists and so forth, and more particularly, for receiving input from a user interacting through the graphical user interface to request performance of an operation for the offer application and functionality for displaying results received from the offer server 228 after performing the requested operation for the offer application.

Other applications may also execute on the user client 202 in various embodiments. For example, in embodiments where the user client 202 may be a computing device such as a mobile phone, an offer application 206 operably coupled with an offer application user interface 208 may execute on the mobile phone. The offer application 206 in this embodiment may have functionality for receiving requests to perform an operation for the offer application and functionality for sending the requests to the offer server 228 to perform the requested operation for the offer application. The offer application user interface 208 in this embodiment may have functionality for visualization and navigation of a graphical user interface for requesting and displaying information about offers available from multiple offer sources, such as brands, product types, offer lists and so forth, and more particularly, for receiving input from a user interacting through the graphical user interface to request performance of an operation for the offer application and functionality for displaying results received from the offer server 228 after performing the requested operation for the offer application.

Moreover, additional applications may execute on the user client 202 that enable notification of updates of offers in various embodiments through multiple notification channels requested by users. For instance, an email application 210 may function both as an instant or periodic notification channel to receive updates about offers and may also function as a communication channel for a user to request performance of an operation for an offer application. Finally, the messaging application 212 may also serve as an instant or periodic notification channel to receive updates about offers and may also function as a communication channel for a user to request performance of an operation for the offer application. The messaging application 212 may be any type of messaging application including an instant messaging application, a text messaging application such as Simple Message Service (SMS), a chat messaging application, and so forth.

In general, the web browser 204, the offer application 206, the offer application user interface 208, the email application 212, and the messaging application 214 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

One or more marketing clients 214 may communicate with one or more offer servers 228 through a network such as network 230. The marketing client 214 may be a computer such as computer system 100 of FIG. 1 or another computing device including a mobile device. A web browser 216 may execute on the marketing client 214 and may include functionality for receiving a request to generate a marketing communication, functionality for tagging the marketing communication, and functionality for sending the marketing communication to a user. The web browser 216 may be operably coupled to a tagging application 220 having functionality for tagging the text of a marketing communication to identify and delineate information about an offer occurring with the text of the marketing communication. The web browser 216 may also be operably coupled to marketing storage 222 that stores marketing messages 224 that may include offer information 226 for several offers. These marketing messages 224 may be tagged to identify and delineate information about an offer including the offer description, the offer expiration date, a coupon code, and so forth. These marketing messages 224 may also be tagged to include and delineate information for use in publishing an offer as an advertisement across digital media in online advertising such as ad channel information, monetization information, social sharing information, and so forth. An email application 218 may also operate on the marketing client 214 having functionality for sending a marketing message 224 to one of more users.

The web browser 216, the email application 210, and the tagging application 220 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

In various embodiments, the user client 202 may communicate with one or more ad servers 232, one or more search servers 252, and one or more publisher servers 262 through a network such as network 230. The ad server 232 may be any type of computer system or computing device such as computer system 100 of FIG. 1. The ad server 232 may generally support services for receiving a request to serve an advertisement and responding to the request to serve an advertisement. In various embodiments, the ad server 232 may include functionality of an advertisement exchange server for third-party ad serving and provide services for publisher servers to add executable instructions to display online advertisements on a client device within allocated space of a web page of content published by the publisher servers. The ad server 232 may also include functionality in various embodiments of an advertisement exchange server for third-party ad serving in sponsored search advertising applications and provide services for search servers to add executable instructions to display online advertisements on a client device within allocated space of a web page of search results returned by the search servers. The ad server 232 may also include functionality for conducting a real-time auction online by requesting real-time bids for third-party ad serving. In other embodiments, the ad server 232 may communicate with an advertisement exchange server where the ad server 232 does not include the functionality of an advertisement exchange server.

In various embodiments, an advertisement serving engine 234 may execute on the ad server 232 and may include functionality for processing requests to serve an advertisement. The advertisement serving engine 234 may include an ad auction engine 236 having functionality for conducting a real-time auction online by requesting real-time bids for third-party ad serving and may also include an ad selector 238 having functionality for selecting one or more advertisements to serve in an ad unit. In various embodiments, the ad selector 238 may select one or more advertisements from bids received for third-party ad serving based upon the bid amount and targeting attributes. The advertisement serving engine 234 may also be operably coupled to ad server storage 240 that stores one or more publisher IDs 242, one or more site IDs 244, one of more ad unit dimensions 246 that may include the location on the web page where ads are displayed. In requesting real-time bids for third-party ad serving, the ad auction engine 236 may send the publisher ID 242, the site ID 244, and ad unit dimensions 246 as part of the information included in the bid request.

The advertisement serving engine 234, the ad auction engine 236, and the ad selector 238 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The search server 248 may be any type of computer system or computing device such as computer system 100 of FIG. 1. In general, the search server 248 may provide services for processing a search query and may include services for requesting a list of advertisements from an advertisement server 232 to be sent to the web browser 204 executing on the client 202 for display with the search results of query processing. For instance, the search server 248 may include functionality in various embodiments that requests third-party ad serving in sponsored search advertising to display online advertisements on a client device within allocated space of a web page of search results returned by the search servers. In particular, the search server 248 may include a search engine 250 for receiving and responding to search query requests, including retrieving, ranking, and sending search results to the web browser 204 executing on the client 202 for display. The search engine 250 may also include functionality in various embodiments to request a list of advertisements from an advertisement server 232 to be sent to the web browser 204 executing on the client 202 for display with the search results of query processing.

The search engine 250 may be any type of executable software code such as a kernel component, an application program, a linked library, an object with methods, a script or other type of executable software code. The search engine 250 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. The search server 248 may be operably coupled to search server storage 252 that may store an index 254 of crawled web pages that may be searched using keywords of the search query to find web pages that may be provided in the search results. The search server storage 252 may also store search result web pages 256 that provide a list of search results with addresses of web pages such as Uniform Resource Locators (URLs).

The publisher server 258 may be any type of computer system or computing device such as computer system 100 of FIG. 1. In general, the publisher server 258 may provide services for processing a request to serve web pages with multimedia content and may include services for requesting a list of advertisements from an advertisement server 232 to be sent to the web browser 204 executing on the client 202 for display with the multimedia content of a web page. For instance, the publisher server 258 may include functionality in various embodiments that requests third-party ad serving to display online advertisements on a client device within allocated space of a web page of multimedia content served by the publisher server. In particular, the publisher server 258 may be operably coupled to publisher server storage 262 that includes one or more web pages 264 such as HTML documents with advertisement executable code. The publisher server 258 may include a content engine 260 for receiving and responding to requests to serve web pages with multimedia content, including retrieving and sending a web page to the web browser 204 executing on the client 202 for display. The content engine 260 may also include functionality in various embodiments to request a list of advertisements from an advertisement server 232 to be sent to the web browser 204 executing on the client 202 for display with the multimedia content on the web page.

The content engine 260 may be any type of executable software code such as a kernel component, an application program, a linked library, an object with methods, a script or other type of executable software code. The content engine 260 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

FIG. 3 presents a block diagram generally representing an exemplary architecture of an offer server for publishing content in marketing communications across digital media in online advertising. The offer server 228 may be any type of computer system or computing device such as computer system 100 of FIG. 1. In general, the offer server 228 may support services for providing promotional offers, offer lists, and for generating offers from marketing communications, and the offer server 228 may support services for receiving a request to serve an advertisement or to bid on a request to serve an advertisement and for responding to the request to serve an advertisement or to bid on a request to serve an advertisement. In particular, the offer server 228 may include a consumer offer application 302 which includes functionality to provide lists of promotional offers from multiple offer sources, including marketing communications. The consumer offer application 302 may include a brand component 304 that manages brand information for brands, a product type component 306 that manages product type information for product types, an offer component 308 that manages offer information for offers, an offer list component 310 that manages offer list information for offer lists, and a consumer application programming interface (API) 312 that may be invoked to perform operations provided by the consumer offer application 302 including operations performed by the brand component 304 for brands, operations performed by the product type component 306 for product types, and operations performed by the offer list component 310 for offer lists. The consumer API 312 may include an offer application programming interface (API) 314 that may be invoked to perform operations, including operations performed by the offer component 308, for promotional offers from multiple sources.

The consumer offer application 302 may be operably coupled to a database engine 324, a recommendation engine 332, a notification engine 264 and a user profile engine 330. The database engine 324 may provide database services and may include a query processor 326 having functionality to process received queries by retrieving the data from the offer server storage 342 and processing the retrieved data. The recommendation engine 332 may also be operably coupled to the database engine 324, the notification engine 328, and the user profile 330. The recommendation engine 332 may provide recommendation services for the various operations of the consumer offer application 302 and may have functionality for receiving requests for recommendations for an operation of the consumer offer application 302, retrieving and ranking results, and returning a list of recommendations for the requested operation of the consumer offer application 302. The notification engine 328 may have functionality for receiving updates to offers, offer lists, and other information for which a user may request notification, and the notification engine 328 may have functionality for sending notification of such updates in various embodiments through multiple notification channels including email application 210 and messaging application 212 described above in conjunction with FIG. 2. The offer server 228 may additionally include a user profile engine 330 that manages user profile information including notification channels assigned to a user.

The offer server 228 may also include a message processor 316 which may be operably coupled with the database engine 324 and the offer generating engine 318. The message processor 316 may include functionality to process marketing messages.

As described in further detail in “A System and Method for Extracting Offers from a Marketing Communication,” U.S. patent application Ser. No. 13/292,022, the message processor 316 may periodically receive marketing messages from marketing communications inboxes for user email accounts in various embodiments, or requests may be sent periodically to the messaging server to retrieve new messages delivered and stored for users email accounts in alternate embodiments.

And the offer server 228 may include an offer generating engine 318 which may be operably coupled to the database engine 324. The offer generating engine 318 may include functionality to extract offer information from marketing messages and generate offers for loading into the offer server storage 342. The offer generating engine 318 may include a message parser 320 with functionality to parse the offer elements in the message such as a brand name, an offer headline, a description of the offer, and so forth. The offer generating engine 318 may also include an ad information parser 322 with functionality to parse advertising information for publishing content in marketing communications across digital media in online advertising such as ad-channel information, monetization information, social sharing information, and so forth.

The offer server 228 may also include an advertising engine 334 which may be operably coupled with the database engine 324. The advertising engine 334 may generally support services for receiving a request to serve an advertisement or to bid on a request to serve an advertisement and for responding to the request to serve an advertisement or to bid on a request to serve an advertisement. In various embodiments, the advertising engine 334 may provide functionality to support third-party ad serving including functionality to respond to a request from an advertisement exchange server to bid on serving an advertisement. The advertisement engine 334 may include an advertising API 336 that provides an application programming interface to advertising servers, a user ID sync engine 338 having functionality for matching a cookie ID received with a request to serve an advertisement from an ad server through cookie-syncing with a cookie ID or user ID stored by the offer server, and an ad bidding engine 340 having functionality to respond to a request to bid on serving an advertisement. In various embodiments, the ad bidding engine 340 may have functionality for determining a bid for each of the one or more advertisements that matches targeting attributes associated with a user ID matching a cookie ID received with a request to serve an advertisement from an ad server.

The consumer offer application 302, each of its components, the database engine 324, the recommendation engine 332, the notification engine 328, user profile engine 330, the message processor 316, the offer generating engine 318, each of its components, and the advertising engine 334 may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The offer server 228 may additionally be operably coupled offer server storage 342 that stores information for brands 344, information for product types 346, a brand address map 348 that associates email addresses with particular brands, information for offers 350, an offer user map 352 that identifies offers associated with a user, an offer advertising information map 353 that associates offers with advertising information, a user ID map 354 that associates cookies received from ad servers associated with user IDs stored on the offer server, advertising information 356 that may be applied in publishing an offer as an advertisement across digital media in online advertising, such as ad channel information, monetization information, social sharing information, and information for user profiles 364 including information of user IDs 368 and shopping friends 370.

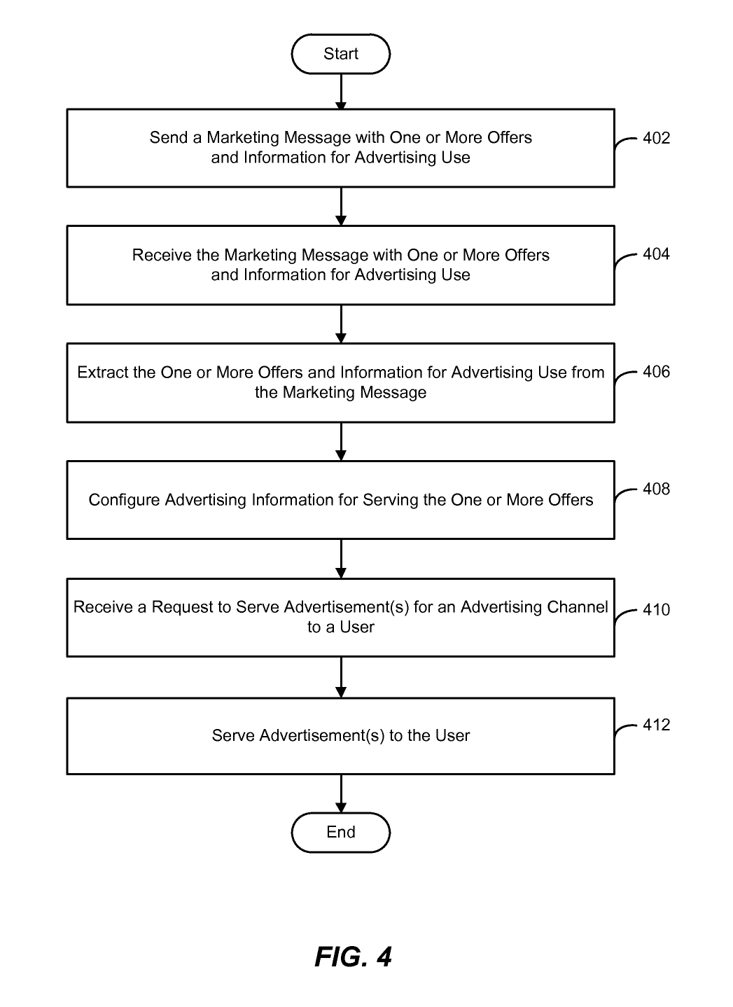

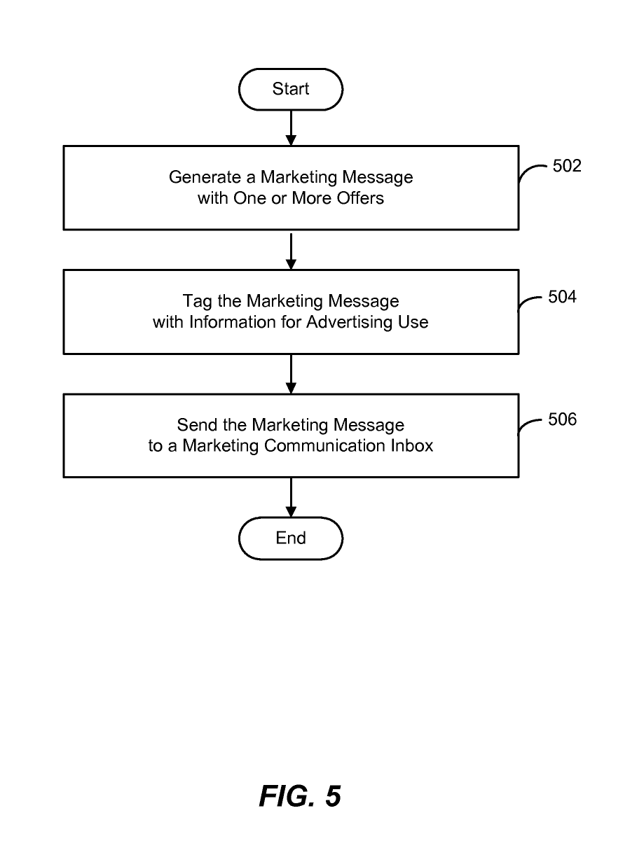

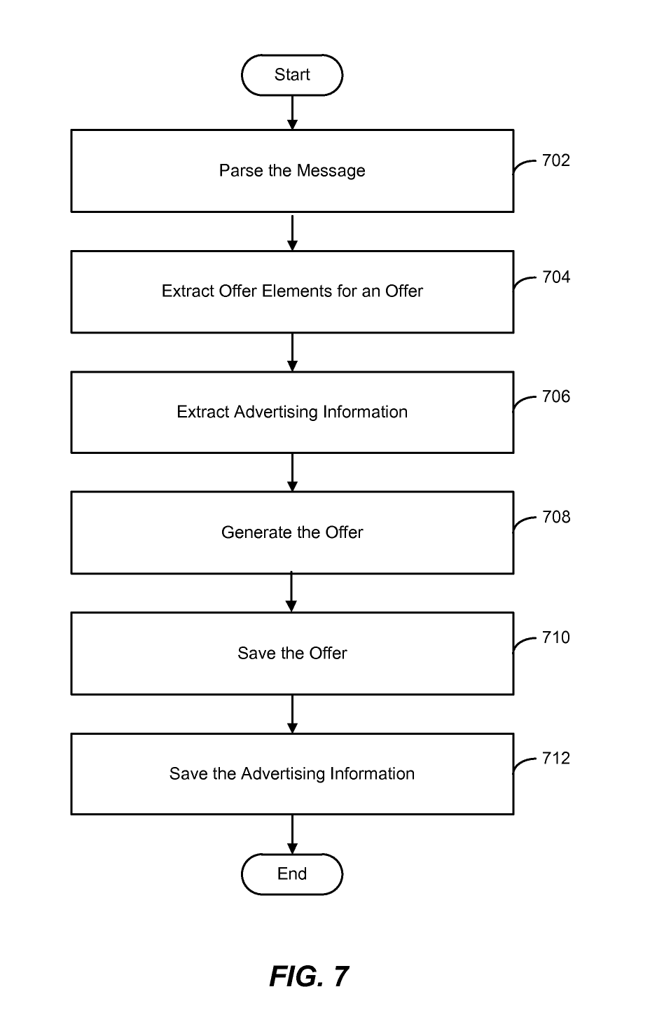

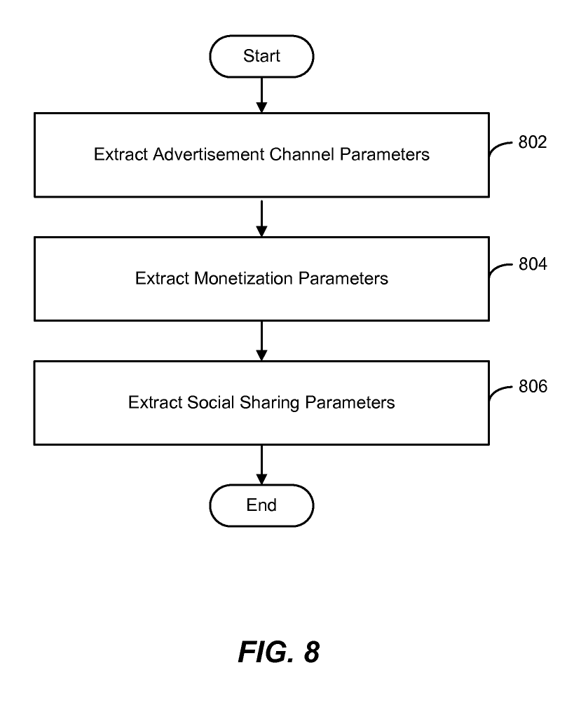

FIG. 4 presents a flowchart generally representing the steps undertaken in one embodiment for publishing content in marketing communications across digital media in online advertising. In general, a marketing message with information about one or more offers and information for using the one or more offers in online advertising may be sent to a particular user at step 402. In an embodiment, a brand may generate and send a marketing message with information about one or more offers and information for using the one or more offers in online advertising as described in detail below in conjunction with FIG. 5. At step 404, the marketing message with information about one or more offers and information for using the one or more offers in online advertising may be received. In an embodiment, the marketing message may be received by a message processing facility such as the message processor 316 of FIG. 3. As described in further detail in “A System and Method for Extracting Offers from a Marketing Communication,” U.S. patent application Ser. No. 13/292,022, the message processor 316 may execute the steps to periodically receive marketing messages from marketing communications inboxes for user email accounts in various embodiments, or, as described in further detail in “A System and Method for Extracting Offers from a Marketing Communication,” U.S. patent application Ser. No. 13/292,022, requests may be sent periodically to the messaging server to retrieve new messages delivered and stored for users email accounts in alternate embodiments. At step 406, information about one or more offers and information for using the one or more offers in online advertising may be extracted from the marketing message. This may be described in an embodiment in further detail below in conjunction with FIGS. 7-8.

In various embodiments, advertising channel parameters may be extracted at step 406 from the marketing message as part of the information for using the one or more offers in online advertising. At step 408, advertising information may be configured for serving the one or more offers that may be extracted at step 406 above from the marketing message. In an embodiment, the offer advertising information map 353 of FIG. 2 may be updated by adding an association of advertising information with the one or more offers extracted from the marketing message. At step 410, a request to serve an advertisement for an advertising channel to a user may be received. Such a request may be received in an embodiment from an advertisement server or advertisement exchange network. And at step 412, an advertisement may be served to a device operated by the user.

FIG. 5 presents a flowchart generally representing the steps undertaken in one embodiment for generating and sending a marketing message with information about one or more offers and information for using the one or more offers in online advertising. At step 502, a marketing message with one or more offers may be generated. In an embodiment, a web browser executing on a client device such as marketing client 214 may be used to compose a marketing message with one or more promotional offers. The offer may include a Uniform Resource Locator (URL) which may be selected to retrieve a web page with further information about the offer or to accept the offer. In alternative embodiments, the marketing message may be selected from a marketing database of composed marketing messages such as marketing messages 224 with offer information 226 stored in marketing database 222. At step 504, the marketing message may be tagged with information for using the one or more offers in advertising. For instance, a tagging application such as tagging application 220 may be used for tagging the text of a marketing communication to identify and delineate information about an offer occurring with the text of the marketing communication. Tags may be inserted to demark each offer occurring with the text of the marketing communication and may further be used to identify and delineate information within an offer including such information as the offer description, the offer expiration date, a coupon code, and so forth.

In an embodiment, the marketing communication may be tagged with advertising information that may be applied in publishing one or more offers as an advertisement across digital media in online advertising, such as ad channel information, monetization information, social sharing information, and so forth. At step 506, the tagged marketing message may be sent to a marketing communication inbox. As used herein, an inbox means a list of email messages received for an email account that are stored for the email account. In an embodiment, an email application such as email application 218 executing on the marketing client 214 may be used to send the marketing message to one or more email accounts with marketing communications inboxes. Those skilled in the art will appreciate that such marketing communications may be sent in various embodiments by various messaging applications like email applications, instant messaging applications, and other messaging applications.

Moreover, those skilled in the art will appreciate that content in a marketing communication, such as promotional content and advertising information, may be tagged, embedded or included using various other techniques in an embodiment. For example, an XML-based language may be used to encode the marketing message so that content within it may be parsed by a parser and stored. As another example, a distinct MIME component may be inserted within an email that defines promotional content such as an offer and may include advertising information, which may be invisible to the user. In yet other embodiments, natural language processing may be applied to insert tags in the marketing message.

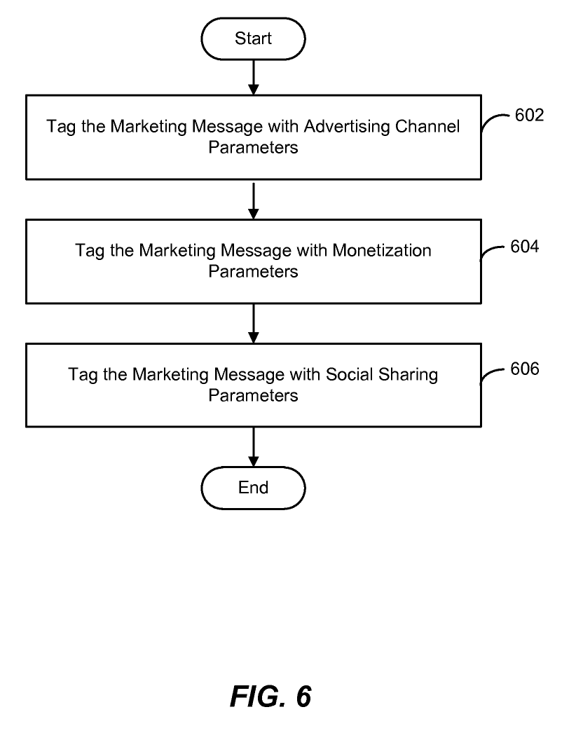

FIG. 6 presents a flowchart generally representing the steps undertaken in one embodiment for tagging a marketing communication with advertising information that may be applied in publishing one or more offers as an advertisement across digital media in online advertising. At step 602, the marketing message may be tagged with advertising channel parameters. Examples of advertising channels may be search advertising including sponsored search advertising, display advertising including targeted display advertising and direct marketing display advertising, email advertising, instant messaging advertising, location-based mobile advertising, general third-party advertisement serving, and other advertising channels for publishing content in marketing communications across digital media in online advertising. In an embodiment, an advertising channel parameter may be a tagged tuple of a tag and value such as “ADCHANNEL Search”, “ADCHANNEL Display”, “ADCHANNEL InstantMsg”, “ADCHANNEL Any”, and so forth. In various embodiments, any advertising channel may be used as a default if a marketing message may not be tagged with an advertising channel parameter. At step 604, the marketing message may be tagged with monetization parameters. For example, a monetization parameter may be a tagged tuple of a tag and value such as “MONETIZE CPA”, “MONETIZE CPC” or “MONETIZE CPM” which may respectively represent the revenue structures of Cost Per Action (CPA), Cost Per Click (CPC) and Cost Per Impression (CPM). And at step 606, the marketing message may be tagged with social sharing parameters. For example, a social sharing parameter may be a tagged tuple of a tag and value such as “SHARE None” or “SHARE Friends”. Thus other users who may be related to the user sent the marketing communication may be specified by social sharing parameters extracted from the marketing message. For instance, shopping friends of a user may be specified in the user profile of FIG. 2, and an offer extracted from a marketing communication sent to a user may be served as an advertisement to friends of the user when a request is received to serve an advertisement to one of the friends of the user.

Those skilled in the art will appreciate that other advertising information may be included in a marketing communication, including targeting attributes, bidding information, keyword parameters, and so forth.

FIG. 7 presents a flowchart generally representing the steps undertaken in one embodiment for processing a marketing communication with advertising information to publish one or more offers as an advertisement across digital media in online advertising. In an embodiment, steps 702 and 704 in FIG. 7 may be executed by the message parser 320 described in conjunction with FIG. 3, step 706 in FIG. 7 may be executed by the ad information parser 322 described in conjunction with FIG. 3, and, and steps 708 and 710 in FIG. 7 may be executed by the offer generating engine 318 described in conjunction with FIG. 3. At step 702, a message may be parsed. In an embodiment, the message parser 320 may be invoked by the offer generating engine 318 in order to extract offers from a message, and the message parser 320 may parse the message structure to identify header components, message metadata, message body, attachments, and so forth. At step 704, offer elements may be extracted from the message for an offer. In an embodiment, the message parser 320 may be invoked by the offer generating engine 318 in order to extract offer elements for an offer, including the brand, headline text, description, and content. At step 706, advertising information may be extracted that may be applied in publishing one or more offers as an advertisement across digital media in online advertising. In an embodiment, advertising information may include ad channel information, monetization information, social sharing information, which is described in detail below in conjunction with FIG. 8.

At step 708, one or more offers may be generated. In an embodiment, the offer generating engine 318 may generate an offer from the offer elements extracted. In various embodiments, the subject of the message may be extracted as the headline of the offer and the first 120 characters in the message body may be extracted as a description of the offer. In other embodiments, an offer may be generated from additional offer elements extracted for an offer, including headline text, description text, URL text, brand name, expiration date, coupon code and so forth. At step 710, the offer may be saved. In an embodiment, the offer may be persistently stored in storage such as offer 350 in offer server storage 342 described in conjunction with FIG. 3. Further details of storing offers in various embodiments may be described in detail in “A System and Method for Extracting Offers from a Marketing Communication,” U.S. patent application Ser. No. 13/292,022. And at step 712, the advertising information may be saved. In an embodiment, the advertising information may be persistently stored in storage such as advertising information 356 in offer server storage 342 described in conjunction with FIG. 3.

FIG. 8 presents a flowchart generally representing the steps undertaken in one embodiment for extracting advertising information from a marketing communication that may be applied in publishing one or more offers as an advertisement across digital media in online advertising. At step 802, advertising channel parameters may be extracted from the marketing message. At step 804, monetization parameters may be extracted from the marketing message. And at step 806, social sharing parameters may be extracted from the marketing message. Those skilled in the art will appreciate that other advertising information may be extracted from marketing messages, including targeting attributes, bidding information, keyword parameters, and so forth.

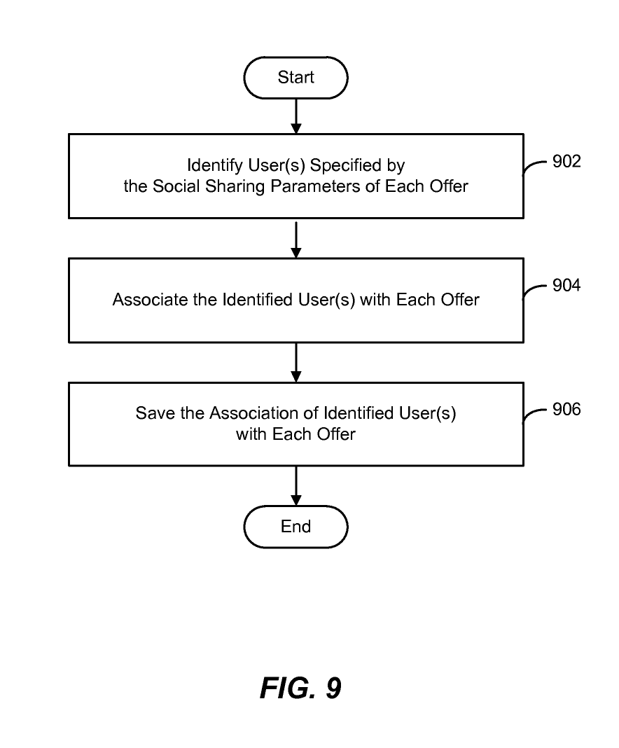

FIG. 9 presents a flowchart generally representing the steps undertaken in one embodiment for associating offers with users identified by social sharing information from a marketing communication to publish one or more offers as an advertisement across digital media in online advertising. At step 902, users specified by social sharing parameters of each offer extracted from the marketing message may be identified. This may be done in an embodiment by looking at shopping friends of a user. For instance, shopping friends in the user profile of FIG. 2. At step 904, users identified from social sharing parameters may be associated with one or more offers extracted from the marketing message. And at step 906, the association of one or more users with one or more offers extracted from the marketing message may be saved in a computer-readable medium. In an embodiment, the offer user map 352 of FIG. 2 may be updated by adding the offers and an association of one or more user with the one or more offers.

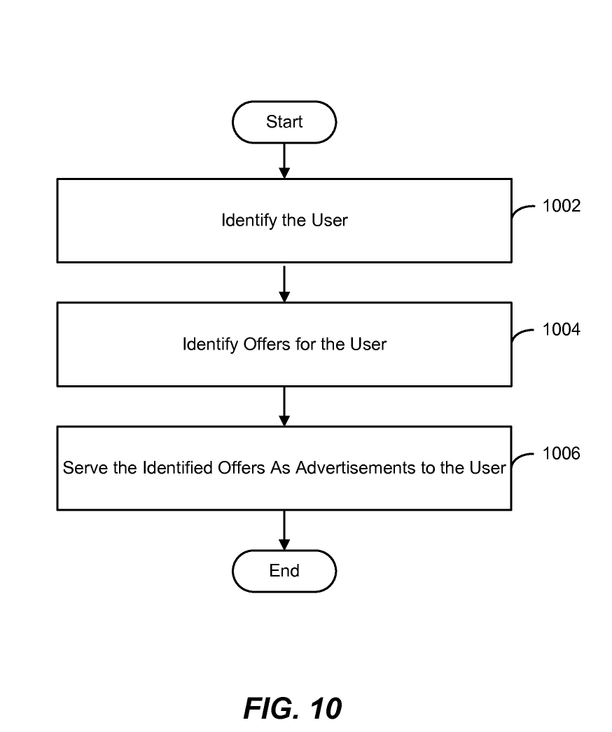

FIG. 10 presents a flowchart generally representing the steps undertaken in an embodiment for serving offers extracted from marketing communications as advertisements to a user. At step 1002, the user may be identified. In various embodiments, a cookie from an advertisement server or advertising network may accompany the request to serve an advertisement. In an embodiment, cookie-syncing known to those skilled in the art may be applied to identify a user stored in the offer server. At step 1004, offers may be identified for the user to serve as an advertisement. In various embodiments, offers may be identified for the user for an advertising channel. At step 1006, the identified offers for the user may be served to the user. In various embodiments, the identified offers for the user may be served to the user for an advertising channel identified in a request from an advertisement server or advertising network to serve an advertisement. Those skilled in the art will appreciate that in embodiments where the computing device of a user may be a mobile phone, an addressable TV, or other device, a user may be identified by synchronization of mobile phone identifiers or other device identifiers.

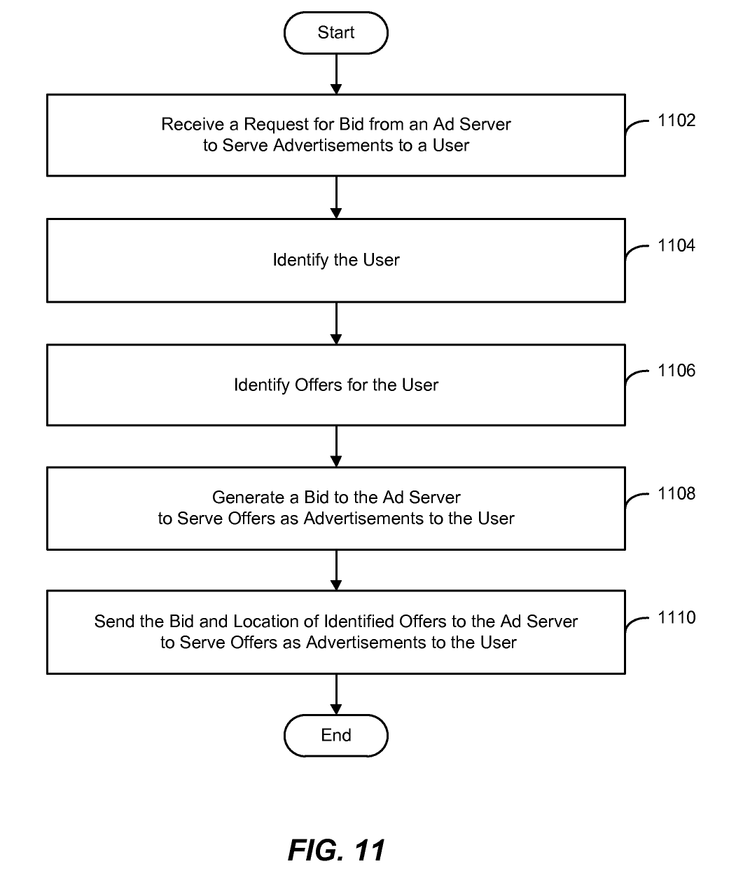

FIG. 11 presents a flowchart generally representing the steps undertaken in an embodiment for responding to a request for a bid from an advertising channel to serve an advertisement to a user. At step 1102, a request may be received for a bid from an advertisement server to serve an advertisement to a user. At step 1104, the user may be identified. In various embodiments, a cookie from an advertisement server or advertising network may accompany the request to serve an advertisement. Cookie-syncing known to those skilled in the art may be applied to identify a user stored in the offer server. At step 1106, offers may be identified for the user. In various embodiments, offers may be identified for the user for an advertising channel. At step 1008, a bid may be generated to serve one or more identified offers to the user as advertisements. In various embodiments, the bid generated may be for serving the identified offers to the user for an advertising channel identified in a bid request from an advertisement server or advertising network. At step 1110, the bid and location of identified offers may be sent to the ad server to serve offers as advertisements to the user.

Thus the present invention may provide marketers the ability to perform effective direct marketing using email marketing to supports sales through other advertising channels. Advantageously, those skilled in the art will appreciate that any number of advertising channels may be supported by the present invention such as search advertising including sponsored search advertising, display advertising including targeted display advertising and direct marketing display advertising, email advertising, instant messaging advertising, location-based mobile advertising, general third-party advertisement serving, and other advertising channels for publishing content in marketing communications across digital media in online advertising. For example, the offer may be published as an advertisement in a checkout flow, IP TV, or digital kiosk in mall. Moreover, any number of configurations of advertisement servers may be employed such as an advertisement server, an advertisement exchange network, functionality in various embodiments for third-party ad serving in sponsored search advertising applications, functionality for conducting a real-time auction online by requesting real-time bids for third-party ad serving, and so forth. Furthermore, those skilled in the art will appreciate that any content from a marketing communication, including the original marketing communication itself in its entirety or derivatives of the original marketing communication, may be published across other digital media in online advertising.

As can be seen from the foregoing detailed description, the present invention provides a system and method for publishing content in marketing communications across digital media. More particularly, the present invention supports inclusion of content in a marketing communication, such as one or more offers, for use in advertising, extracting and storing the content for use in advertising, and serving the content to a user in response to a request to serve an advertisement in online advertising. Such a marketing communication may include and delineate information for use in publishing content as an advertisement across digital media in online advertising. As a result, the system and method provide significant advantages and benefits needed in contemporary computing and in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for serving an advertisement, comprising:
a server that receives a request to serve the advertisement to a user in online advertising;
an advertising engine operably coupled to the server that identifies at least one offer extracted from a marketing message sent to the user with information for using the offer in online advertising; and
a server storage operably coupled to the advertising engine that stores in a computer-readable medium the at least one offer extracted from the marketing message sent to the user and an association of the at least one offer extracted from the marketing message with an identification of the user.

2. The system of claim 1 further comprising a user identification synchronization engine operably coupled to the advertising engine that applies cookie-syncing to match a cookie in the request to serve the advertisement to the user in online advertising with another cookie associated with the user sent the marketing message with information for using the offer in online advertising.

3. The system of claim 1 further comprising an advertisement bidding engine operably coupled to the advertising engine that generates a bid to serve the advertisement to the user in online advertising.

4. The system of claim 1 further comprising a message processor operably coupled to the server that parses a message structure of the marketing message sent to the user.

5. The system of claim 1 further comprising an offer generating engine operably coupled to the server that extracts the at least one offer from the marketing message sent to the user.

6. The system of claim 5 further comprising a message parser operably coupled to the offer generating engine that parses a plurality of elements of the at least one offer in the marketing message sent to the user.

7. The system of claim 5 further comprising an advertising information parser operably coupled to the offer generating engine that parses information in the marketing message for using the offer in online advertising.

8. The system of claim 1 wherein the server storage operably coupled to the offer extract engine that stores the at least one offer extracted from the marketing message sent to the user and the association of the at least one offer extracted from the marketing message with an identification of the user further comprises an association of the at least one offer extracted from the marketing message with information from the marketing message for using the at least one offer in online advertising.

9. The system of claim 1 further comprising a marketing client operably coupled to the server that sends the marketing message to an email account of the user assigned to the server.

10. The system of claim 9 further comprising a tagging application operably coupled to the marketing client that tags the text of the marketing message to identify and delineate information about the at least one offer occurring with the text of the marketing message.

11. The system of claim 9 further comprising a tagging application operably coupled to the marketing client that tags a plurality of offer elements and advertising information in the text of the marketing message.

12. The system of claim 1 further comprising an advertising server operably coupled to the server that supports services for receiving the request to serve the advertisement and responding to the request to serve the advertisement.

13. The system of claim 12 further comprising a search server operably coupled to the advertising server that sends the request to serve the advertisement.

14. The system of claim 12 further comprising a publisher server operably coupled to the advertising server that sends the request to serve the advertisement.

15. A computer system for serving an advertisement, comprising:
a server that receives a request to serve the advertisement to a user in online advertising;
an advertising engine operably coupled to the server that identifies at least one offer extracted from a marketing message sent to another user with information for using the offer in online advertising; and
a server storage operably coupled to the advertising engine that stores in a computer-readable medium the at least one offer extracted from the marketing message sent to the another user and an association of the at least one offer extracted from the marketing message with an identification of the user.

16. The system of claim 15 further comprising a user identification synchronization engine operably coupled to the advertising engine that applies cookie-syncing to match a cookie in the request to serve the advertisement to the user in online advertising with another cookie associated with the user identified as a friend of the another user sent the marketing message with information for using the offer in online advertising.

17. The system of claim 15 further comprising an advertisement bidding engine operably coupled to the advertising engine that generates a bid to serve the advertisement to the user in online advertising.

18. The system of claim 15 further comprising an advertising server operably coupled to the server that supports services for receiving the request to serve the advertisement and responding to the request to serve the advertisement.

19. The system of claim 18 further comprising a publisher server operably coupled to the advertising server that sends the request to serve the advertisement.

20. A computer system for serving an advertisement, comprising:
means for receiving a request to serve the advertisement to a user in online advertising;
means for identifying at least one offer extracted from a marketing message sent to the user with information for using the offer in online advertising; and
means for outputting the at least one offer extracted from the marketing message sent to the user with information for using the offer in online advertising.
